(19) United States
(12) Patent Application Publication
(10) Pub. No.: US 2010/0148495 A1
(43) Pub. Date: Jun. 17, 2010

(54) DEVICE, METHOD AND KIT OF PARTS FOR FORMING A PRESS-FIT CONNECTION WITH A TUBE

(75) Inventors: Alan Richard Glaze, Bromsgrove (GB); Steven Paul Webb, Tipton (GB)

Correspondence Address: JONES DAY, 222 EAST 41ST ST, NEW YORK, NY, 10017, US

(73) Assignee: IBP IPR Limited, Tipton (GB)

(21) Appl. No.: 12/636,169

(22) Filed: Dec. 11, 2009

(30) Foreign Application Priority Data
Dec. 12, 2008 (EP) 08021611.2

(51) Int. Cl. F16L 55/00; F16L 37/00

(52) U.S. Cl. 285/39; 285/344

(57) ABSTRACT

A device for forming a press-fit connection with a tube, the device including a socket for insertion of an end section of the tube. The socket includes a wall having at least a first section extending in axial direction, the first section having at least one annular bead providing a housing for at least partially accommodating a sealing element within the socket, and two second sections. Each second section is located immediately adjacent to a bead and commences at a position along an axis of the socket at which a magnitude of a derivative of an outside radius of the wall with respect to the axial position has a local minimum. In addition, each second section has, for every azimuthal position, an inside radius with a minimum at an axial position where the first and second sections terminate and the minimum radius of each second section is smaller than the inside radius at the axial position where the second section commences.

### CROSS-REFERENCE TO RELATED APPLICATIONS

This application claims the benefit of European Application No. 08021611.2, filed on Dec. 12, 2008, the entire contents of which are hereby incorporated by reference.

### BACKGROUND OF THE INVENTION

1. Field of the Invention

Embodiments of the present invention relate to a device for forming a press-fit connection with a tube.

Embodiments of the present invention also relate to a method of enabling an increase in compression of an annular sealing element in a press-fit connection, where the annular sealing element is configured to be at least partially accommodated in a housing provided on an inside of a bead formed in a wall of a socket for receiving an end section of a tube.

In addition, embodiments of the present invention relate to a kit of parts for forming a press-fit connection with a tube, including a press-fit tool and a device having a socket for receiving an end section of the tube.

2. Description of Related Art

EP 1 431 643 A is directed to a press connection arrangement comprising a tube that can be inserted into a pressable section of a fitting or armature. The fitting or armature consists of a cold-workable material. A bulge is formed in the pressable section, in which a sealing ring is accommodated. Adjacent the bulge is a cylindrical section adjoined by an outwardly expanding housing for a holding element. During the pressing action, a press tool annularly grips the pressable section and presses onto its outer surface, whereby the sealing ring is clamped tight to the outer surface of the tube to seal the connection.

EP 1 167 853 A2 is directed to a pressure fitting for tubes. The fitting consists of a tubular body with a longitudinal axis and having at least at one end, a peripheral bulging. Internally, this bulging defines a round recess, open towards the axis of the body and designed to house a round grommet. The bulging and the corresponding recess that it defines, reveals, in cross-section, the shape of a practically rectangular trapezium, with a radial side that extends outwards from the tubular body almost perpendicularly to the longitudinal axis of the fitting, with a sloping free side at the free end of the fitting, which is angled so as to diverge with respect to the radial side as it goes towards the fitting axis, with a die or external shorter base that is slightly convex, essentially parallel to the axis of the body and joining together at the top the radial side and the sloping side, in order to define the opening of the recess towards the fitting axis. In one version, the sloping side of the bulging extends as a cylindrical portion, running parallel to the tube to be connected on the opposite side of the tubular body of the fitting itself The radial wall, which is essentially perpendicular to the surface of the tube, constitutes a flat shoulder, without giving any scope to a space or cone with the tube itself.

DE 10 2006 050 427 A1 is directed to a press fitting with a bead for receiving an O-ring on the inside. The bead corresponds to the O-ring in cross-section, with an essentially concentrically arranged crown section of the bead, viewed in axial direction of the fitting, transitioning on both sides into flanks, which continue into a cylindrical wall of the fitting. Press jaws of a press tool are provided with three different sections of press geometry as seen in an axial direction, starting with a first press geometry formed by a bead press section formed as a cylindrical section. FIG. 16 is a detailed cross-sectional view of a section of a fitting in accordance with DE 10 2006 050 427 A1. FIG. 16 shows the fitting in the un-pressed state. The a magnitude of a first derivative of the outside radius of the fitting wall has a minimum at axial positions marked Z1 and Z3. The apex of the bead is at a position marked Z2.

### SUMMARY OF THE INVENTION

It is therefore an object of the embodiments of the present invention to provide a device and method of the types mentioned above that address the problems and shortcomings of the state of the art. In particular, the socket wall design should enable a relatively high degree of compression of the sealing element, resulting in good pressure-tightness, to be achieved, but the bead should retain its roundness and basic shape to a relatively large degree.

A first embodiment of the present invention provides a device for forming a press-fit connection with a tube, the device including a socket for insertion of an end section of the tube, the socket being defined by a wall. The wall includes at least one first section extending in an axial direction, the first section including at least one annular bead and two second sections where the bead(s) provide a housing for at least partially accommodating a sealing element within the socket. Each second section is located immediately adjacent the bead(s) and commences at a position along an axis of the socket at which a magnitude of a derivative of an outside radius of the wall with respect to its axial position has a local minimum, wherein each second section has, for every azimuthal position, an inside radius with a minimum at an axial position where the first and second section terminate, and wherein the minimum radius of each second section is smaller than the inside radius at the axial position where the second section commences.

In at least one of the second sections, the wall may have a thickness that decreases towards the adjacent bead. Alternatively, in at least one of the second sections, the wall may have an outside radius that varies along an axial direction with the inside radius.

In one embodiment, the device includes at least one annular sealing element having at least one recess along its circumference for providing a leakage path prior to pressing when a tube is inserted therein and, in particular, a recess located adjacent at least one bulge. The minimum radius of each second section may correspond to a minimum radius of the socket, at least on the side of the adjacent bead on which the second section is provided. Additionally, in at least one of the second sections, the inside radius may increase continually along its axial position towards the adjacent bead.

Further, each second section may terminate at a position of transition to an essentially cylindrical section of the wall.

In another embodiment, the at least one bead is configured to be able to accommodate an annular sealing element with a cross-sectional diameter having a maximum value D, and a depth of the bead, corresponding to a difference between an inside radius of the wall at an axial position where the second section commences and a maximum inside radius of the wall at an axial position where the bead is provided, is at least equal to half the maximum value D. In a variant of this embodiment, a difference between the minimum inside radius of the second section and the maximum inside radius of the wall is larger than the maximum value D.

In another embodiment, as can be seen in a longitudinal cross-section taken parallel to the longitudinal axis of the socket, a tangent to an inside of the wall is at an angle of 20° or less at every axial position within each second section.

According to another embodiment of the present invention, there is provided a method of enabling an increased compression of an annular sealing element in a press-fit connection, in which the annular sealing element is configured to be at least partially accommodated in a housing provided on an inside of a bead formed in a wall of a socket for receiving an end section of a tube. The method includes providing the wall with sections on either side of the bead that have an inside radius that increases towards the bead in axial direction for every azimuthal position, wherein a device according to the embodiments of the present invention is provided.

In one embodiment, the sealing element is compressed using a tool including at least two co-operating jaws configured to envelop at least a portion of the first section when placed around the device, such that compression of the annular sealing element is due to a larger extent to the downward movement of the bead rather than to deformation of the bead.

In a variant of this embodiment, the inside radius of the wall at each axial position corresponding to a transition between the bead and an adjacent second section is set such that a difference between this radius and a minimum inside radius of at least the first section of the socket is at most equal to a difference between a maximum outside radius of the bead when the jaws first contact the bead and a maximum outside radius of the bead when the jaws are finally closed upon pressing.

Another embodiment of the method includes providing the annular sealing element and the tube, wherein the annular sealing element has an inside diameter larger than the outside diameter of the end section of the tube.

In another embodiment, the method may include providing the annular sealing element and the tube, wherein the annular sealing element is dimensioned such that, with the end section of the tube inserted through the annular sealing element and into the socket, a clearance for forming a leakage path is provided between the annular sealing element and the housing provided on the inside of a bead.

Another embodiment of the present invention is directed to a kit of parts for forming a press-fit connection with a tube. The kit includes a press-fit tool and a device including a socket for insertion of an end section of the tube according to the embodiments of the present invention invention.

In one embodiment, the tool includes at least two cooperating jaws configured to envelop at least part of the first section of the wall when placed around the device, wherein an inside radius of the wall at each axial position corresponding to a transition between the bead and an adjacent second section is set such that a difference between this radius and a minimum inside radius of at least the first section of the socket is at most equal to a difference between a maximum outside radius of the bead when the jaws first contact the bead and a maximum outside radius of the bead when the jaws are finally closed upon pressing.

In yet another embodiment, the tool includes at least two cooperating jaws configured to envelop at least part of both second sections when placed around the device.

The jaws may define an opening with an inside diameter when closed, wherein a wall thickness of the second sections is such that an inside of the second sections is generally cylindrical in shape when the second sections are pressed to such an extent that their outside radius at least the respective points of commencement correspond to an inside diameter defined by the jaws.

The jaws may be configured to envelop both second sections and at least parts of respective adjacent sections of the wall, wherein the jaws are provided with an inside profile imparting a non-circular cross-sectional shape to the adjacent sections of the wall when the jaws are closed.

The tool may include at least two cooperating jaws configured to exert a pressing force on the bead, contacting only the bead upon application to the wall.

The embodiments of the present invention are based on the surprising insight that, because the minimum radius of each second section is smaller than the inside radius at the axial position where the second section commences, at least the base of the bead is raised a relatively large distance away from the outside surface of the tube in the pre-pressed condition. Compression is due to a larger extent to the downward movement of the bead, as opposed to deformation of the bead. The lower deformation means that lower forces are required to achieve compression of the annular sealing element. This also means that the base of the bead does not necessarily dig into the tube when the sealing element is compressed. This is the case at each azimuthal position (i.e. the inside profile is of a generally similar configuration, though not necessarily of the exact same dimensions, for every longitudinal cross-section through the center axis of the socket). Therefore, deformations of the tube that could make it unround or non-circular can be largely avoided, at least where the first section of the wall of the socket and particularly the bead is concerned, even where a press tool with two jaws is used. This is even the case where a pressing tool is used that imparts a non-circular cross-sectional, e.g. hexagonal, shape to sections of the socket wall adjacent the first section. The second sections prevent progression of the deformation to the bead.

Because there are two second sections each located immediately adjacent a bead, compression of the sealing element is symmetrical, and full downward movement of the base of the bead is assured. This improves the pressure-tightness. The sealing element remains essentially centralized in the housing provided by the bead. In contrast to a chamfered inside edge of the base of the bead, each second section commences at a position along an axis of the socket at which the magnitude of a derivative of an outside radius of the wall with respect to axial position is at a local minimum. It is thus adjacent and not below the base of the bead or bases of the beads and therefore, makes downward movement of the bead without deformation of the (side) walls of the bead possible. This is achieved without affecting the shape of the bead, in particular without an increase in its inside opening angle. Thus, the suitability of the housing for preventing the sealing element from being dislodged when the tube is inserted is unaffected. Moreover, for a given desired final degree of compression, the higher compression achieved with the pressing action means that a smaller amount of pre-compression due to insertion of the tube is required. This reduces the risk of damage to the sealing element or dislodgment of the sealing element by the face of the tube as it is inserted into the socket. The minimum inside radii at the terminations of the second sections contribute to alignment of the tube, at least during the pressing action.

A variant embodiment of the device in which, in at least one of the second sections, the wall has a thickness that decreases towards the adjacent bead, provides a configuration that can be manufactured efficiently using a machining operation. Starting with cylindrical precursors to the second sections, a machining operation need only be carried out on the inside of the device.

An alternative embodiment where, in at least one of the second sections, the wall has an outside radius varying essentially with the inside radius in axial direction, is suitable for a larger range of manufacturing processes, including forming. If the second sections are formed, then machining is not required. If forming is used, then the manufacturing process is made easier with this profile, because the bead wall can transition more gradually into the second sections than would be the case if the bead were situated immediately adjacent cylindrical sections. It is noted that the outside radius varies essentially with the inside radius in axial direction in the sense that, as the inside radius increases in axial direction, so does the outside radius, so that they vary in parallel, preferably to the same absolute extent.

If the device includes at least one annular sealing element having at least one recess along its circumference for providing a leakage path prior to pressing when a tube is inserted and, in particular, a recess situated adjacent at least one bulge, the additional compression achievable by increasing the height of the housing provided by the bead in the pre-pressed state is put to very good use. In particular, the annular sealing element can be dimensioned with respect to the tube that the socket is designed to accommodate such that the amount of pre-compression on insertion of the tube is relatively low. This means that it is practically impossible for the recess providing the leakage path to be closed merely due to insertion of the tube. The additional compression provided by the raised bead ensures that the total amount of compression in the final, pressed state is still sufficient to close the leakage path and provide a tight seal.

If the minimum radius of each second section corresponds to a minimum radius of the socket, at least on the side of the adjacent bead on which the second section is provided, then better alignment of the tube is achieved. A tube with the appropriate outside diameter is guided by the wall at the position of the terminations of the second sections. These positions provide fulcrum points for the second sections during the pressing operation, such that the insides of the second sections are brought up against the inserted tube by the pressing operation. An effect of this is to provide for controlled deformation of the socket.

In another embodiment, in at least one of the second sections, the inside radius increases continually along its axial position towards the adjacent bead. Compared with a stepped shape, little axial displacement of material occurs during the pressing operation when the insides of the second sections are pressed against the tube. This means that less force is required. A further effect is that deformation of the tube at a position corresponding to the “base” of a step in the wall of the socket due to the pressing force is avoided. The continual increase is in one embodiment at an essentially constant rate with respect to axial position. It could also be at an increasing rate (i.e. the insides of the second sections curve upwards towards the base of the bead), to raise the bead even further. In both cases, the inside of the wall in the second sections “unrolls” against the inserted tube when the press force is applied. There is therefore a low risk of damage to the tube, in particular, a low risk of pinching the tube.

Where each second section terminates at a position of transition to an essentially cylindrical section of the wall, the problem of deformation of the tube, which results in an unround or non-circular shape if a pliers-like press-fit tool is used, is alleviated further. The point of minimum inside radius of the second section is at the termination thereof, away from the bead. This point acts as a fulcrum when the second section is caused to collapse towards the inserted tube. The cylindrical sections spread the force applied at the fulcrum point. They also improve the alignment of the tube with respect to the central axis of the socket.

Where the at least one bead is configured to be able to accommodate an annular sealing element with a cross-sectional diameter having a maximum value D, and a depth of the bead, corresponding to a difference between an inside radius of the wall at an axial position where the second section commences and a maximum inside radius of the wall, is at least equal to half the maximum value D, an inserted sealing element is held more firmly in place prior to insertion of the tube. In particular, if a difference between the minimum inside radius of the second section and the maximum inside radius of the wall is larger than the maximum value D, there is essentially no risk that the annular sealing element might become dislodged on insertion of the tube. This is also true for non-circular cross-sectional shapes of the annular sealing element, provided the difference between an inside radius and an outside radius of the annular sealing element is smaller than or equal to the maximum diameter D. It is noted that, although the term annular sealing element is used herein, such sealing elements are generally toroids—shapes obtainable by revolving a surface around an adjacent axis. The term cross-sectional diameter is used herein to denote the diameter of the revolved surface.

As can be seen in a longitudinal cross-section taken parallel to the longitudinal axis of the socket, a tangent to an inside of the wall is at an angle of 20° or less at every axial position within each second section, then the risk of damage to the inserted tube during pressing is further reduced. A pressing force exerted on the bead will tend to move the second section up against the tube, rather than being transferred along the wall in the second section. Thus, there is less deformation of the tube due to the end of the second and first section being pressed into the tube. There is also less deformation of the bead.

The method of enabling an increased compression of an annular sealing element in a press-fit connection according to the embodiments of the present invention allows one to provide a tighter seal or to provide a seal that is tight enough, but requires less pre-compression due to insertion of the tube.

If compression of the annular sealing element is due to a larger extent to downward movement of the bead rather than to deformation of the bead, then the risk of leaks at certain azimuthal positions is reduced because a substantially circumferentially symmetric compression with respect to a longitudinal axis of the socket is obtained.

In a practical implementation, in which the compression of the annular sealing element is essentially exclusively due to movement of the bead towards the pipe, the base of the bead is at such a radial distance to the inserted pipe, that when the jaws have closed completely, the base just touches the pipe. Thus, the base of the bead, which is not deformed to any appreciable extent, impresses its round shape on the inserted tube. This is achieved due to the fact that, in this embodiment, an inside radius of the wall at each axial position corresponding to a transition between a bead and an adjacent second section is set such that a difference between this radius and a minimum inside radius of at least the first section of the socket is at most equal to, generally slightly less than, a difference between a maximum outside radius of the bead when the jaws first contact the bead and a maximum outside radius of the bead when the jaws are finally closed upon pressing. The minimum inside radius of at least the first section of the socket will generally correspond to the outside radius of the tube for which the fitting is provided. This is in any case true for the minimum inside radius of the overall socket, the socket being that part of the device up to a stop, e.g. a shoulder, for preventing further insertion of a tube.

Where the method involves providing the annular sealing element and the tube, and the annular sealing element has an inside diameter larger than the outside diameter of the end section of the tube, no pre-compression is provided at all. Instead a pre-press leakage indicator is provided, as fluid can pass between the inserted tube and the annular sealing element. Nevertheless, due to the increased compression obtainable by the pressing operation, the seal in the pressed condition is still very good.

A similar leakage indicator is provided if the annular sealing element is dimensioned such that, with the end section of the tube inserted through the annular sealing element and into the socket, a clearance for forming a leakage path is provided between the annular sealing element and the housing provided on the inside of a bead. In this case, the leakage path is between the outside of the annular sealing element and the inside of the housing provided for it by the bead, instead of, or in addition to, the leakage path between tube and annular sealing element.

It is envisaged that the device be used in conjunction with a press-fit tool. The tool can include a pair of jaws configured to envelop at least part of both second sections when placed around the device. In fact, the tool may envelop only the first section or part of the first section, so that it is ensured that the space between the tube and the second sections collapses when the jaws are closed. Alternatively, the tool may have jaws with an inside profile adapted to the socket wall and comprising sections corresponding to the first section and adjacent sections. At least the profile section corresponding to the first section is designed to effect a reduction in diameter of the first section of the socket wall that is distributed generally evenly along the circumference. There is thus less pinching of the bead.

In another embodiment, the pair of jaws defines an opening having an inside diameter when closed, wherein a wall thickness of the second sections is such that an inside of the second sections is generally cylindrical in shape when the second sections are pressed to such an extent that their outside radii at at least the respective points of commencement correspond to the inside diameter of the jaws. Thus, the insides of the second sections of the wall of the socket provide a holding force on the tube. The use of grip rings or retaining elements is not required.

When the jaws are configured to envelop both second sections and at least parts of respective adjacent sections of the wall and the jaws are provided with an inside profile imparting a non-circular cross-sectional shape to the adjacent sections of the wall, when the jaws are closed, the retention of the tube in the socket is brought about by the sections deformed to a non-circular cylindrical shape. The jaws preferably impart a generally circular cross-sectional shape to the first section of the socket wall, i.e. the bead and adjacent second sections. The second sections can act as a barrier to prevent the bead from being deformed in the same manner as the sections that are deformed to a non-circular cross-sectional shape.

### BRIEF DESCRIPTION OF THE DRAWINGS

Embodiments of the present invention will now be explained in further detail with reference to the accompanying drawings, in which:

FIG. 1 is a perspective view of a section of a coupler comprising a device for forming a press-fit connection, according to an embodiment of the present invention;

FIG. 2 is an end view along a central axis of the device depicted in FIG. 1;

FIG. 3 is a cross-sectional view along line A-A in FIG. 2;

FIG. 4 is a perspective view of a section of a coupler comprising a device for forming a press-fit connection, according to an embodiment of the present invention;

FIG. 5 is an end view along a central axis of the device depicted in FIG. 4;

FIG. 6 is a cross-sectional view along line A-A in FIG. 5;

FIG. 7 is a perspective view of a section of a coupler comprising a device for forming a press-fit connection, according to an embodiment of the present invention;

FIG. 8 is an end view along a central axis of the device depicted in FIG. 7;

FIG. 9 is a cross-sectional view along line B-B in FIG. 8;

FIG. 10 is a plan view of an O-ring for use in any of the device depicted in FIGS. 1-9, according to an embodiment of the present invention;

FIG. 11 is a cross-sectional view along A-A in FIG. 10;

FIG. 12 is a cross-sectional view along B-B in FIG. 10;

FIG. 13 is a cross-sectional view along C-C in FIG. 10;

FIG. 14 is a cross-sectional view of the device depicted in FIGS. 7-9, with an O-ring and a tube inserted prior to forming a press-fit connection;

FIG. 15 is an enlarged cross-sectional view of a part of the assembly depicted in FIG. 14, showing the O-ring in a housing formed by a bead; and

FIG. 16 is an enlarged cross-sectional view of a press fitting according to the prior art.

### DESCRIPTION

Embodiments of a device for forming a press-fit connection with a tube are described herein. Each device is an integral part of a fitting, such as, for example, a coupler or coupling, connector, reducer, elbow, bend, tee, stop end, flange, or the like.

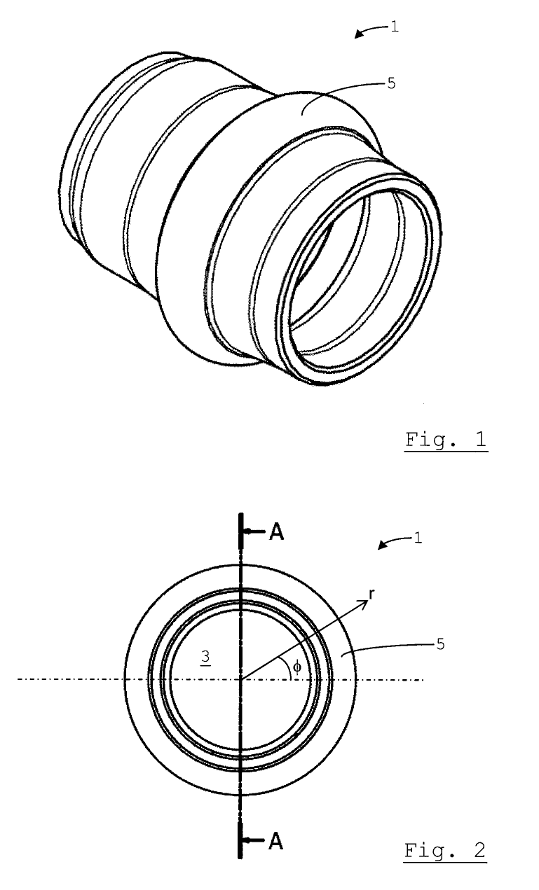

A first embodiment of a device for forming a press-fit connection with a tube is depicted in FIGS. 1-3. As shown, the device 1 comprises a socket S for insertion of or for receiving an end section of a tube (not shown). The socket S is defined by a wall 2 and extends from an insertion opening 3 to a shoulder 4. Thus, the socket S is the section of the device 1 that accommodates an inserted end section of a tube with a diameter for which the device is intended. The end face of such a tube abuts against the shoulder 4, when fully inserted.

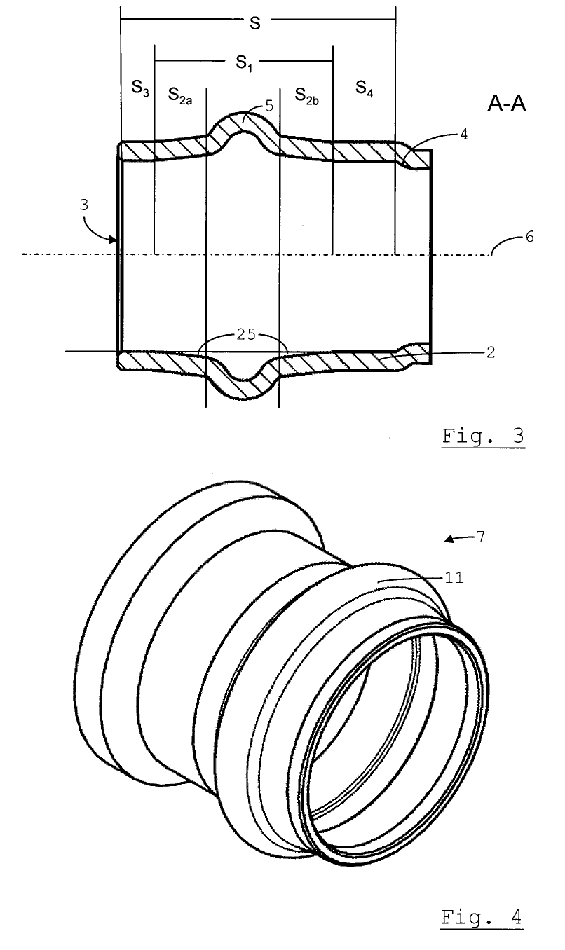

FIG. 3 shows a longitudinal cross-section along the line A-A in FIG. 2. Viewed in an axial direction, i.e. generally parallel to the direction of insertion of the tube, the wall 2 defining the socket includes a first longitudinal section S₁, which includes a bead 5 and second sections S₂ₐ and S_{2b} on either side of the bead 5. First and second cylindrical sections S₃ and S₄ are provided adjacent the second sections S₂ₐ and S_{2b}. The inside of the bead 5 provides a housing for at least partially accommodating an annular sealing element (not shown in FIGS. 1-3), which is discussed below.

It is useful to define a cylindrical coordinate system as indicated in FIG. 2, such that a point is defined by its azimuthal position (φ), radial position (r), and a position (x) along a central axis 6 of the socket S. Thus, a first derivative with respect to an axial position (x) is dr/dx.

A longitudinal cross-section at every azimuthal position (φ) has a shape as illustrated in FIG. 3. In other embodiments, however, the dimensions and shapes may vary. In other words, in other embodiments, the device 1 may not be circumferentially symmetric. However, as depicted in FIG. 3, the illustrated embodiment of the device 1 is circumferentially symmetric. This provides an even distribution of compression forces when the press-fit connection is established.

As can be seen in FIG. 3, the inside of each second section S₂ₐ and S_{2b} curves upwards towards the adjacent bead 5 from an axial position at which the inside radius is a minimum, which is where the second sections S₂ₐ and S_{2b} terminate and transition into the adjoining cylindrical section S₃ and S₄. The minimum inside radius of the second sections S₂ₐ and S_{2b} is essentially equal to the minimum radius of the entire socket, which is slightly larger than the outer radius of the tube intended to be inserted. In the illustrated embodiment, in each second section S₂ₐ and S_{2b}, the inside radius increases essentially linearly along its axial position towards the bead 5. The maximum inside radius is at the axial position where the second sections S₂ₐ and S_{2b} commence, i.e. join the bead 5. As a consequence, the height of the base of the bead above an inserted tube is relatively large, given the radius of curvature of the bead 5. In the device 1, the maximum height of the housing provided by the bead 5 above an inserted tube is also relatively high. In effect, the entire bead 5 is “lifted up.”

The profile of the socket S of the device 1 is obtainable by forming, e.g. using rolls, hydroforming or a combination of at least one die and an expandable insert. The device 1 can also be cast. The wall 2 material can be, for example stainless steel, carbon steel, copper, a copper alloy, or the like.

Being formed, the thickness of the wall 2 in the second sections S₂ₐ, and S_{2b} is essentially constant. The shape of the device 1 depicted in FIG. 3 is relatively easy to manufacture because, adjacent the axial position where the magnitude of the derivative of the outside radius of the wall 2 with respect to axial position has a local minimum, in other words, where second sections S₂ₐ and S_{2b} transition into the side walls of the bead 5, the bead 5 has a relatively large radius of curvature. Thus, there is no sharp fold where the bead 5 joins the second sections S₂ₐ and S_{2b}.

Further, as can be seen in a longitudinal cross-section taken parallel to the longitudinal axis of the socket such as the cross-section depicted in FIG. 3, a tangent to an inside of the wall is at an angle of 20° or less at every axial position within each second section.

A second embodiment of a device for forming a press-fit connection with a tube is depicted in FIGS. 4-6. As shown, the device 7 comprises a socket S′ for insertion of or for receiving an end section of a tube (not shown). The socket S′ is defined by a wall 8, and extends from an insertion opening 9 to a shoulder 10. The end face of a tube for which the second device 7 is designed abuts against the shoulder 10, when fully inserted.

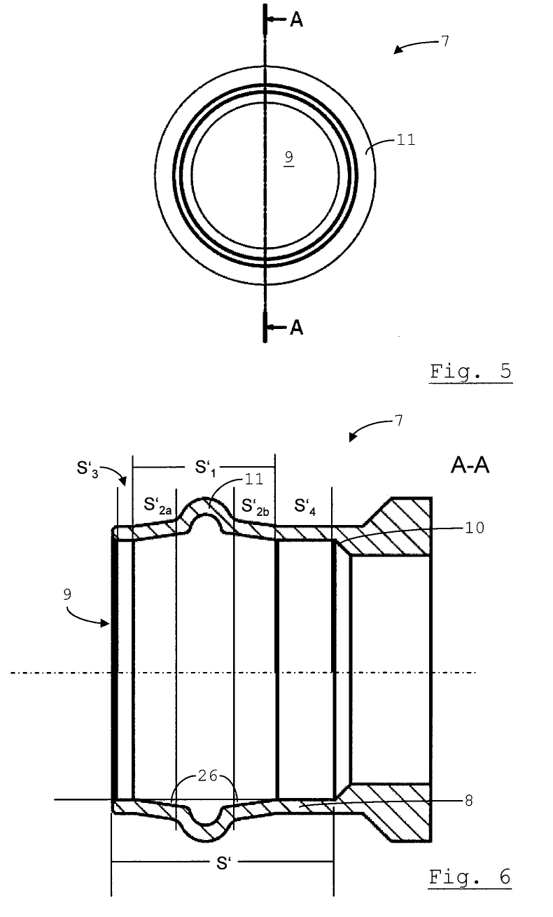

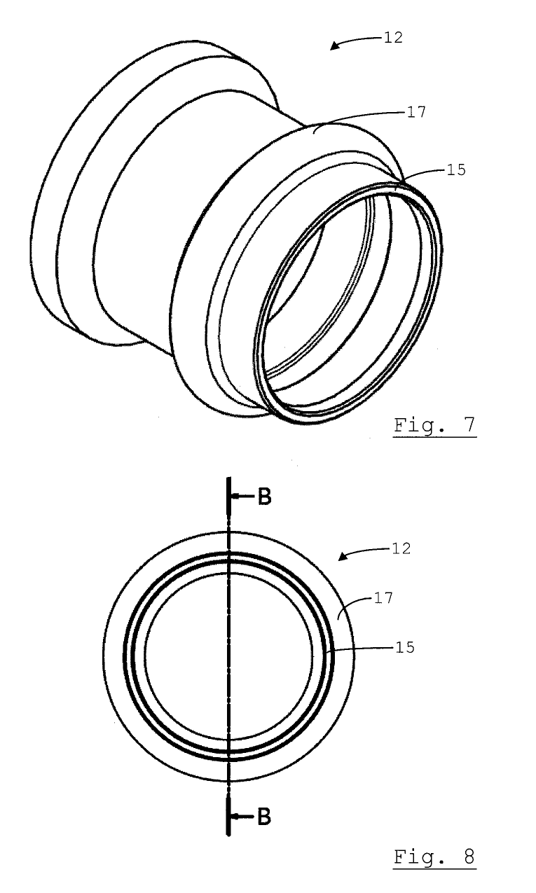

As depicted in the cross-section in FIG. 6, the wall 8 defining the socket S′ includes a first longitudinal section S′₁, which includes a bead 11 and second sections S′₂ₐ and S′_{2b} on either side of the bead 11. First and second cylindrical sections S′₃ and S′₄ are provided adjacent the second sections S′₂ₐ and S′_{2b} on either side of the first section S′₁. The inside of the bead 11 provides a housing for at least partially accommodating an annular sealing element (not shown in FIGS. 4-6), which is discussed below.

A longitudinal cross-section at every azimuthal position (φ) has a shape as illustrated in FIG. 5. The illustrated device 7 is essentially circumferentially symmetric. In other embodiments, however, the dimensions and shapes may vary. In other words, in other embodiments, the device 7 may not be circumferentially symmetric.

The inside radius of each second section S′₂ₐ and S′_{2b} increases linearly along its axial position towards the adjacent bead 11 from an axial position at which the inside radius is at a minimum, which is where the second sections S′₂ₐ and S′_{2b} transition into the adjoining cylindrical section S′₃ and S′₄. The maximum inside radius is at the axial position where the second sections S′₂ₐ and S′_{2b} commence, i.e. joins the bead 11. In addition, the minimum inside radius of the second sections S′₂ₐ and S′_{2b} is also essentially equal to the minimum radius of the entire socket S′, and slightly larger than the outer radius of the tube intended to be inserted. Thus, the cylindrical sections S′₃, and S′₄ align the tube, when inserted.

Also, given the radius of curvature of the bead 11 in the device 7, the height of the base of the bead 11 above an inserted tube is relatively large. Thus, the second sections S′₂ₐ, S′_{2b} “lift up” the base of the bead 11. Further, in the device 7, the maximum height of the housing formed by the bead 11 above an inserted tube is also relatively high.

The profile of the socket S′ of the device 7 is obtainable by machining, generally after forming, e.g. using rolls, hydroforming or a combination of at least one die and one or more expandable inserts. The device 7 can also be cast and then machined. The material of the wall 8 can be, for example, stainless steel, carbon steel, copper, a copper alloy, or the like.

Because the inside and outside radius of the second sections S′₂ₐ, and S′_{2b} both increase continually and at the same rate towards the bead 11, the wall thickness is generally constant. Thus, the shape of the second sections S′₂ₐ, and S′_{2b} is essentially frusto-conical.

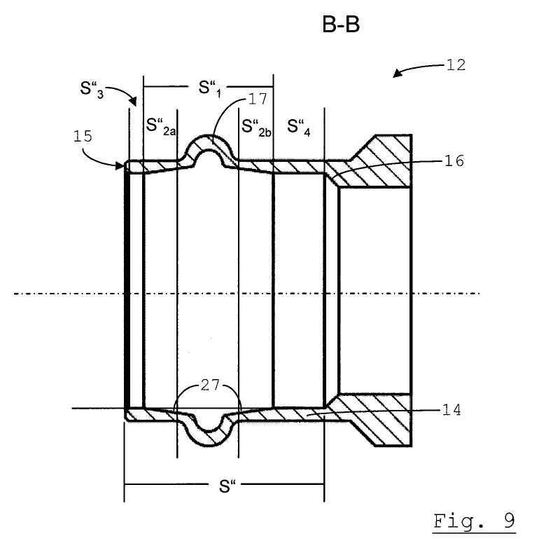

A third embodiment of a device for forming a press-fit connection with a tube is depicted in FIGS. 7-9 and 14-15. As shown, the device 12 comprises a socket S″ for insertion of an end section of a tube 13 (depicted in FIG. 14). The socket S″ is defined by a wall 14, and extends from an insertion opening in an end face 15 of the device 12 to a shoulder 16. The tube 13 abuts against the shoulder 16, when fully inserted as shown in FIG. 14.

As illustrated in FIG. 9, the wall 14 can be divided into axial sections. A first section S″₁ includes a bead 17 and second sections S″₂ₐ and S″_{2b} on either side of the bead 17. First and second cylindrical sections S″₃ and S″₄ are provided adjacent the second sections S″₂ₐ and S″_{2b} on either side of the first section S″₁. The inside of the bead 17 provides a housing for at least partially accommodating an annular sealing element 18 as depicted in FIG. 14 and as discussed below.

A longitudinal cross-section at every azimuthal position φ has a shape as illustrated in FIG. 9. The illustrated third device 12 is essentially circumferentially symmetric. In other embodiments, however, the dimensions and shapes may vary. In other words, in other words, the device 12 may not be circumferentially symmetric.

The inside radius of each second section S″₂ₐ and S″_{2b} increases continuously, in fact, essentially linearly, along its axial position towards the adjacent bead 17 from an axial position at which the inside radius is at a minimum. This position where the inside radius is at a minimum is where the second sections S″₂ₐ and S″_{2b} transition into the adjoining cylindrical sections S″₃ and S″₄. The minimum inside radius of the second sections S″₂ₐ and S″_{2b} is also essentially equal to the minimum radius of the entire socket S″, and slightly larger than the outer radius of the tube 13. Thus, prior to pressing, the tube 13 is aligned by the cylindrical sections S″₃ and S″₄.

Additionally, in the device 12, the base of the bead 17 is also “lifted up” due to the profile of the adjacent second sections S″₂ₐ and S″_{2b}, but the maximum height of the housing for the sealing element 18 is not particularly large, given the diameter of the bead 17

The profile of the socket S″ of the device 12 is obtainable by machining only the inside of the wall 14 in the region of the bead 17 and second sections S″₂ₐ and S″_{2b}. The material of the wall 14 can be, for example, stainless steel, carbon steel, copper, a copper alloy, or the like.

In contrast to the devices 1 and 7 of the previous embodiments, the wall thickness of the present device 12 is not constant in the second sections S″₂ₐ and S″_{2b}. As can be seen in FIG. 9, the wall 14 tapers towards the bead 17. The taper is provided only on the inside of the socket S″. On the outside, the second sections S″₂, and S″_{2b} form continuations of the adjacent cylindrical sections S″₃ and S″₄.

A sealing ring 18 for use as a sealing element in any of the device 1,7, 12 is illustrated separately in FIGS. 10-13. This sealing ring 18 includes pre-press leak indication features, which exploit the relatively large compression available with the socket design presented herein.

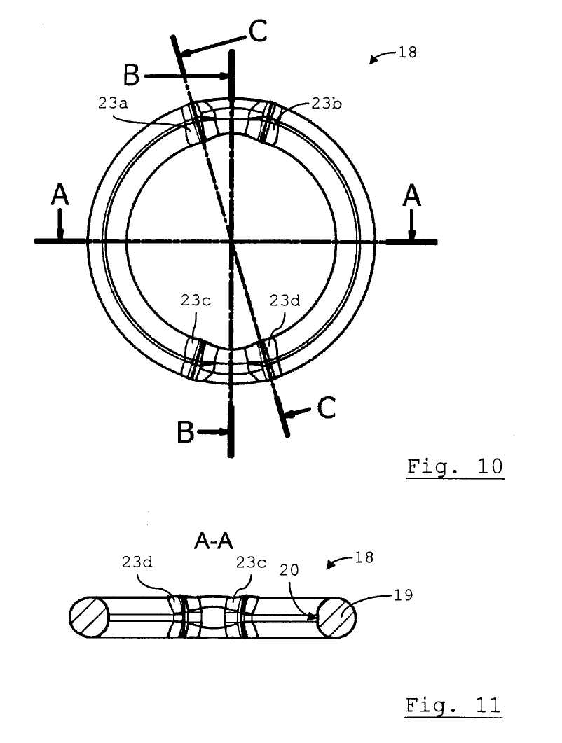

As illustrated in FIG. 11, the sealing ring 18 has a first cross-sectional shape 19, along a majority of its circumference. This first shape 19 has a flattened part 20 defining an inner circumference of the sealing ring 18. In an alternative embodiment (not shown), the first shape 19 is completely rounded so that the flattened part 20 is absent. The contour or shape of the first shape 19 is otherwise rounded along its cross-sectional circumference, although not with the same radius of curvature everywhere.

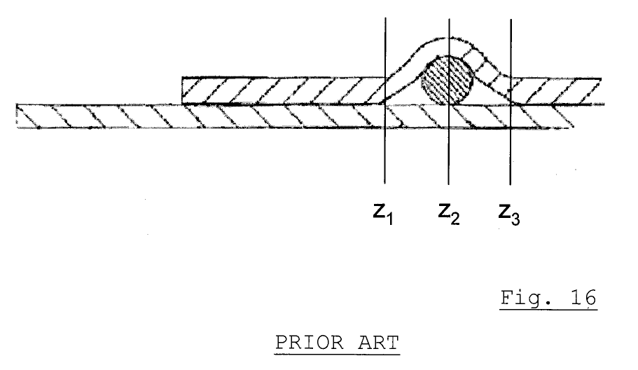

The sealing ring 18 has a maximum inside diameter at a circumferential position corresponding to the cross-section identified by line B-B in FIG. 10 and shown as cross-sectional view B-B in FIG. 12. In FIG. 12, the sealing ring 18 has a second cross-sectional shape 21 with an area that is a minimum for all circumferential positions. Again, the second shape 21 has a flattened part 22 defining an inner circumference of the sealing ring 18. The contour of the second shape 21 is otherwise rounded, although not with the same radius of curvature everywhere. In fact, if one defines the height h₁ of the second shape 21 as half the difference between the outside diameter and the inside diameter of the sealing ring 18 at this circumferential position, then the radius of curvature decreases to a value substantially lower than half the height on either side of the flattened part 22 of the inside of the sealing ring 18. The radius of curvature is also slightly smaller than half the height at the apex of the second shape 21, which forms the outside of the sealing ring 18. As is clear from FIG. 15, this shape helps center the sealing ring 18 in the housing provided by the bead 17.

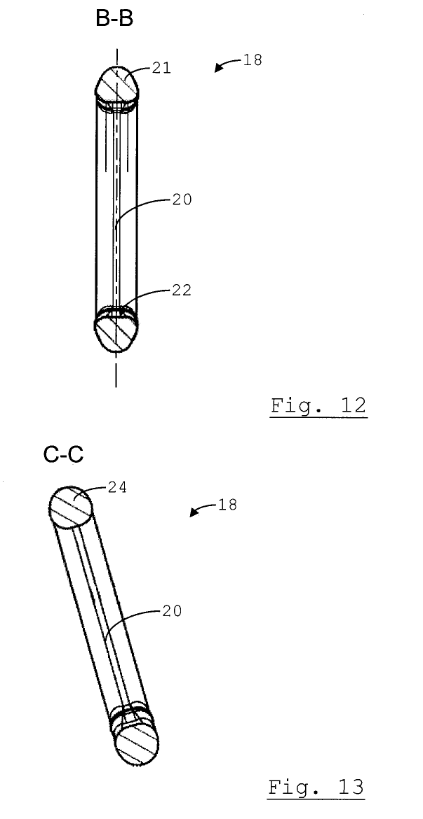

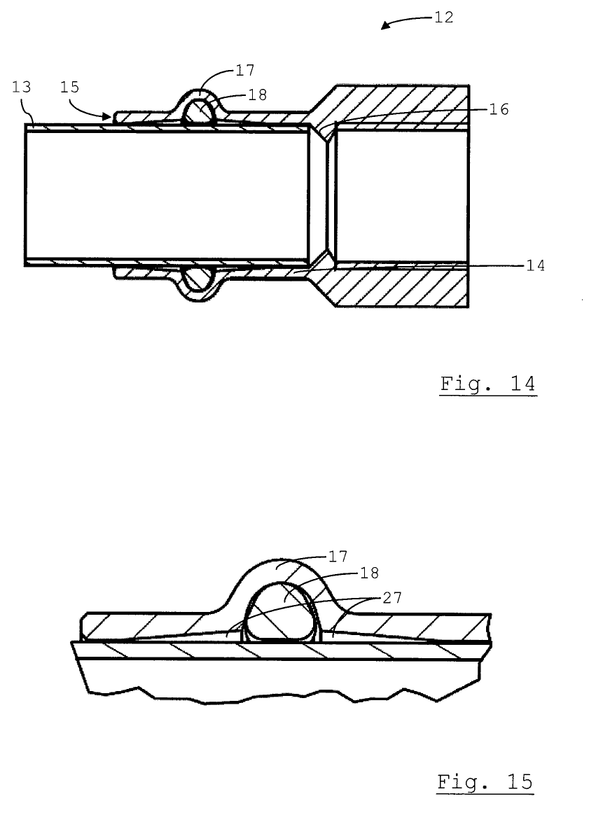

As depicted in FIGS. 10 and 11, on either side of the portion of the sealing ring 18 having the maximum inside diameter, are projections 23a-23d. These projections 23a-23d have a third cross-sectional shape 24 as shown in FIG. 13 where their cross-sectional area is at a maximum. The characteristics of the second shape 21 set out above also describe the third shape 24.

As can be seen in FIGS. 10 and 12, the projections 23a-23d and the portion of the sealing ring 18 with the second cross-sectional shape 21 define a gap on the inside of the sealing ring 18. That is, as described above, the inside diameter of the sealing ring 18 is at a maximum in the areas between the projections 23a-23d. The additional volume provided by the projections 23a-23d compared to a continuation of the first cross-sectional shape 19 along that portion of the circumference is slightly less than the volume missing from the portion with the second cross-sectional shape 21 compared to a continuation of the first cross-sectional shape 19 along that portion of the circumference. When the sealing ring 18 is compressed due to the reduction in height of the housing provided by the bead 17, the material of the projections 23a-23d is displaced to fill the gaps between them. In the pre-press condition with the tube 13 inserted through the sealing ring 18 the amount of pre-compression of the sealing ring 18 is insufficient to close the gaps between the projections 23a-23d.

With reference to FIG. 15 and the lower halves of the cross-sections of FIGS. 3, 6 and 9, it can be seen that the second sections S₂ₐ, S_{2b}, S′₂ₐ, S′_{2b}, S″₂ₐ, and S″_{2b} define annular spaces 25,26,27, respectively, that collapse when a pressing force is applied to at least the beads 5,11,17. Thus, the height of the beads 5,11,17 is reduced, due to the fact that the beads 5,11,17 move downwards towards the tube 13, rather than because the beads 5,11,17 deform.

Although a press collar can be used as a press tool, it is envisaged that a pliers-like tool (not shown) or a power tool with a pair of clamping jaws will be used. The jaws are configured to envelop at least part of both second sections S₂ₐ, S_{2b}, S′₂ₐ, S′_{2b}, S″₂ₐ, and S″_{2b} when placed around the device 1,7,12. The jaws can have various profiles. An example of a suitable profile is that of the KSP 24 inserts for press tools available from Gustav Klauke GmbH, but a variety of equally suitable alternative tools and tool inserts are available from various other providers. Such tools or tool inserts provide jaws configured to envelop both second sections S₂ₐ, S_{2b}, S′₂ₐ, S′_{2b}, S″₂ₐ, and S″_{2b} and at least parts of the first and second cylindrical sections S₃, S_{4,} S′₃, S′₄, S″₃, and S″₄ of the walls 2; 8; 14. The jaws are provided with an inside profile imparting a non-circular cross-sectional shape to the first and second cylindrical sections S₃, S_{4,} S′₃, S′_{4,} S″₃, and S″₄ when the jaws are closed or clamped down. When pressure or a clamping force is applied to the beads 5, 11, 17, the beads 5,11,17 and second sections S₂ₐ, S_{2b}, S′₂ₐ, S′_{2b}, S″₂ₐ, and S″_{2b} are merely reduced in diameter and thus do not deform, retaining their essentially circular cross-sectional shape.

The jaws of the press tool define an opening with an inside diameter such that when closed, the jaws cannot be moved closer together. The wall thickness of the second sections S₂ₐ, S_{2b}, S′₂ₐ, S′_{2b}, S″₂ₐ, and S″_{2b} is such that the inside of the second sections S₂ₐ, S_{2b}, S′₂ₐ, S′_{2b}, S″₂ₐ, and S″_{2b} is generally cylindrical in shape when the second sections S₂ₐ, S_{2b}, S′₂ₐ, S′_{2b}, S″₂ₐ, and S″_{2b} are compressed to such an extent that their outside diameters at at least the respective points of commencement correspond to the inside diameter of the jaws. In this position, the base of the beads 5,11,17 is positioned in contact against the tube 13.

In an alternative embodiment, the press tool can include at least two cooperating jaws configured to exert a pressing force on the beads 5, 11, 17 and, more particularly, on only the beads 5, 11, 17, at least upon application to the wall. This ensures that the beads 5,11,17 are moved towards the inserted tube 13 when the jaws are closed. The jaws are configured to exert a force on the beads 5,11,17 that is generally symmetrical with respect to a plane through an apex of the beads 5,11,17 and perpendicular to a longitudinal axis of the device 1,7,12.

Additionally, it may be the case that the jaws impart a hexagonal cross-sectional shape to certain sections of the device 1,7,12, in particular, the second sections S₂ₐ, S_{2b}, S′₂ₐ, S′_{2b}, S″₂ₐ, and S″_{2b} and/or at least parts of the first and second cylindrical sections S₃, S₄, S′₃, S′₄, S″₃, and S″₄. Because deformation of the bead 5,11,17 is essentially prevented, this hexagonal cross-section will not extend to the bead 5,11,17, thereby reducing the risk of leakage.

The inside diameter of the jaws at the axial position corresponding to the beads 5,11,17 is such that, when the jaws are completely closed, the outside radius of the beads 5,11,17 is reduced by an amount substantially equal to, or slightly larger than, the radial distance between the base of the beads 5,11,17 and an inserted tube. If the amount is generally equal, there is little or no deformation of the beads 5,11,17. Thus, the beads 5, 11, 17 retain their essentially round shape, helping to prevent leakage. If, however, the reduction is slightly larger than the radial distance between the base of the beads 5,11,17 and an inserted tube 13, then the beads 5,11,17 are still not appreciably deformed, but it impresses its round shape on the tube 13. This similarly helps prevent leakage.

It is observed that the sealing ring 18 described and illustrated in detail herein is not the only type of sealing element that can be advantageously employed in the device 1,7,12 discussed herein. In particular, the sealing ring described in detail in EP 1 847 753 A1, the contents of which are hereby incorporated by reference, also has at least one recess along its circumference for providing a leakage path prior to pressing when a tube is inserted. Thus, this sealing ring can be used as an alternative to the sealing ring 18 described herein.

Alternatively, an O-ring with a substantially circular or D-shaped cross-section along its entire circumference can be used, when appropriately dimensioned. In one embodiment, the O-ring or D-ring has an inside diameter larger than the outside diameter of the end section of the tube 13. In that case, a leakage path is provided between the tube 13 and the annular sealing path when the tube 13 is inserted, and the annular sealing element is not pre-compressed at all. This minimizes the risk of damage to the annular sealing element that can be caused by sharp edges on the end face of the tube 13 as it is inserted through the annular sealing ring. It also decreases the risk that the annular sealing ring will be dislodged upon insertion of the tube 13.

An alternative leakage path can be provided between the annular sealing element and the beads 5,11,17, if the annular sealing element is provided with a small enough outside diameter and cross-sectional diameter. The leakage path is closed by the downward movement of the beads 5,11,17. The same effect is provided where the leakage path is between the inside of the annular sealing element and the tube 13, e.g. where the inside diameter of the annular sealing element is larger than the outside diameter of the tube 13.

In another embodiment of the present invention, the device 1, 7, 12 can include an annular sealing element having at least one recess along its circumference for providing a leakage path prior to pressing when a tube is inserted and, in particular, a recess situated adjacent at least one bulge. With this sealing element, the additional compression achievable by increasing the height of the housing provided by the bead in the pre-pressed state is put to very good use. In particular, the annular sealing element can be dimensioned with respect to the tube that the socket is designed to accommodate such that the amount of pre-compression on insertion of the tube is relatively low. This means that it is practically impossible for the recess providing the leakage path to be closed merely due to insertion of the tube. The additional compression provided by the raised bead ensures that the total amount of compression in the final, pressed state is still sufficient to close the leakage path and provide a tight seal.

The features disclosed in the foregoing description, the following claims and/or accompanying drawings, expressed in their specific forms or in terms of means for performing the disclosed function or a method or process for attaining the disclosed result, as the case may be, may be applied separately or in any combination for the purpose of realizing the invention in its various forms.

For example, the second sections S₂ₐ, S_{2b}, S′₂ₐ, S′_{2b}, S″₂ₐ, and S″_{2b} may be provided on either side in the axial direction of a section comprising two or more beads, each providing a housing for an annular sealing element, such that their height is collectively raised by the second sections S₂ₐ, S_{2b}, S′₂ₐ, S′_{2b}, S″₂ₐ, and S″_{2b}. Alternatively, the first sections S₁,S′₁, and S″₁ described above may be repeated one or more times along an axial direction of the socket.

### LIST OF REFERENCE NUMERALS

1 First embodiment of a device for forming a press-fit connection with a tube
2 Wall
3 Insertion opening
4 Shoulder
5 Bead
6 Central axis
7 Second embodiment of a device for forming a press-fit connection with a tube
8 Wall
9 Insertion opening
10 Shoulder
11 Bead
12 Third embodiment of a device for forming a press-fit connection with a tube
13 Tube
14 Wall
15 End face
16 Shoulder
17 Bead
18 Sealing ring
19 First cross-sectional shape of sealing ring
20 Flattened part of sealing ring
21 Second cross-sectional shape of sealing ring
22 Flattened part of sealing ring
23a-d Projections
24 Third cross-sectional shape of sealing ring
25 Annular space
26 Annular space
27 Annular space

What is claimed:

1. A device for forming a press-fit connection with a tube, the device comprising:
a socket for insertion of an end section of the tube, the socket being defined by a wall, wherein the wall comprises at least one first section extending in an axial direction, the first section including at least one annular bead and two second sections, the bead providing a housing for at least partially accommodating a sealing element within the socket,
wherein each second section is located immediately adjacent to a bead and commences at a position along an axis of the socket at which a magnitude of a derivative of an outside radius of the wall with respect to the axial position has a local minimum,
wherein each second section has, for every azimuthal position, an inside radius with a minimum at an axial position where the first and second sections terminate, and
wherein the minimum radius of each second section is smaller than the inside radius at the axial position where the second section commences.

2. The device according to claim 1, wherein the wall thickness of at least one of the second sections decreases along its axial direction towards the adjacent bead.

3. The device according to claim 1, wherein in at least one of the second sections, the wall has an outside radius that varies with the inside radius along the axial direction.

4. The device according to claim 1, wherein the device includes at least one annular sealing element having at least one recess along its circumference for providing a leakage path prior to pressing when a tube is inserted into the device, and wherein the recess is located adjacent at least one bulge.

5. The device according to claim 1, wherein the minimum radius of each second section corresponds to a minimum radius of the socket at least on the side of the adjacent bead on which the second section is provided.

6. The device according to claim 1, wherein in at least one of the second sections, the inside radius increases continually along its axial position towards the adjacent bead.

7. The device according to claim 1, wherein each second section terminates at a position of transition to an essentially cylindrical section of the wall.

8. The device according to claim 1, wherein the at least one bead accommodates an annular sealing element having a cross-sectional diameter with a maximum value D, and wherein a depth of the bead, corresponding to a difference between an inside radius of the wall at an axial position where the second section commences and a maximum inside radius of the wall at an axial position where the bead is provided, is at least equal to half the maximum value D.

9. The device according to claim 8, wherein a difference between the minimum inside radius of the second section and the maximum inside radius of the wall is larger than the maximum value D.

10. The device according to claim 1, wherein in a longitudinal cross-section taken parallel to a longitudinal axis of the socket, a tangent to an inside of the wall is at an angle of 20° or less at every axial position within each second section.

11. A method of forming a press-fit connection with a tube comprising the steps of:
providing a socket for insertion of an end section of the tube, the socket being defined by a wall, wherein the wall comprises at least one first section extending in an axial direction, the first section including at least one annular bead and two second sections, the bead providing a housing for at least partially accommodating a sealing element within the socket,
wherein each second section is located immediately adjacent to a bead and commences at a position along an axis of the socket at which a magnitude of a derivative of an outside radius of the wall with respect to the axial position has a local minimum,
wherein each second section has, for every azimuthal position, an inside radius with a minimum at an axial position where the first and second sections terminate, and
wherein the minimum radius of each second section is smaller than the inside radius at the axial position where the second section commences;
providing an annular sealing element in the housing formed by the bead;
inserting an end of the tube into the socket; and
compressing the device and the annular sealing element onto the end of the tube.

12. The method according to claim 11, wherein the device and the sealing element are compressed using a tool having at least two cooperating jaws configured to envelop at least part of the first section when placed around the device, such that compression of the annular sealing element is due to a larger extent to the downward movement of the bead rather than to deformation of the bead.

13. The method according to claim 12, wherein an inside radius of the wall at each axial position corresponding to a transition between the bead and an adjacent second section is set such that a difference between this radius and a minimum inside radius of at least the first section of the socket is at most equal to a difference between a maximum outside radius of the bead when the jaws first contact the bead and a maximum outside radius of the bead when the jaws are finally closed upon pressing.

14. The method according to claim 12, wherein the annular sealing element is dimensioned such that when the end section of the tube is inserted through the annular sealing element and into the socket, a clearance for forming a leakage path is provided between the annular sealing element and the housing formed on the inside of the bead.

15. A kit for forming a press-fit connection with a tube comprising:
a press-fit tool; and
the device according to claim 1.

16. The kit according to claim 15, wherein the tool comprises at least two cooperating jaws configured to envelop at least a portion of the first section when placed around the device, and wherein an inside radius of the wall at each axial position corresponding to a transition between the bead and an adjacent second section is set such that a difference between this radius and a minimum inside radius of at least the first section of the socket is at most equal to a difference between a maximum outside radius of the bead when the jaws first contact the bead and a maximum outside radius of the bead when the jaws are finally closed upon pressing.

17. The kit according to claim 15, wherein the tool comprises at least two cooperating jaws configured to envelop at least a portion of both second sections when placed around the device.

18. The kit according to claim 17, wherein the jaws define an opening having an inside diameter when closed, wherein a wall thickness of the second sections is such that an inside of the second sections is generally cylindrical in shape when the second sections are pressed to such an extent that their outside radii at at least the respective points of commencement correspond to an inside diameter defined by the jaws.

19. The kit according to claim 17, wherein the jaws are configured to envelop both second sections and at least portions of respective adjacent sections of the wall, wherein the jaws are provided with an inside profile imparting a non-circular cross-sectional shape to the adjacent sections of the wall when the jaws are closed.

20. The kit according to claim 15, wherein the tool comprises at least two cooperating jaws that exert a pressing force on the bead at least upon application to the wall.

21. The kit according to claim 20, wherein the two cooperating jaws contact only the bead of the first section upon first application to the wall.

22. A method of enabling an increased compression of an annular sealing element in a press-fit connection comprising the steps of:
providing a device having a socket defined by a wall, wherein the wall comprises:
an annular bead forming a housing therein; and
at least one section on either side of the bead, the section having an interior radius that increases towards the bead in an axial direction for every azimuthal position so that the height in a pre-pressed condition of an opening of the housing above a tube to be received by the socket is higher than the adjacent portions of the wall; and
providing an annular sealing element to be at least partially accommodated in the housing.
